(19) United States
(12) Patent Application Publication
(10) Pub. No.: US 2024/0274303 A1
(43) Pub. Date: Aug. 15, 2024

(54) Controlled Fusion Reactor

(71) Applicant: David Allen LaPoint, Bend, OR (US)

(72) Inventor: David Allen LaPoint, Bend, OR (US)

(21) Appl. No.: 18/108,329

(22) Filed: Feb. 10, 2023

Related U.S. Application Data
(60) Provisional application No. 63/310,521, filed on Feb. 15, 2022.

(51) Int. Cl. G21B 1/05; H01F 7/02; H01F 7/20

(52) U.S. Cl. CPC G21B 1/05; H01F 7/02; H01F 7/20

(57) ABSTRACT

A controlled fusion reactor that is constructed using two opposing bowl-shaped magnetic arrays that are covered by U.S. Pat. No. 8,638,186 B1 by the same inventor. The opposing bowl-shaped magnetic arrays are contained within a chamber under a high vacuum level and can be fed a controlled amount of a gas, such as hydrogen. Electrodes located in the bottom of the bowl-shaped arrays and the conductive screens surrounding the rim of the bowl-shaped magnetic arrays are supplied with high-voltage electricity which causes a high-velocity jet of plasma to be ejected from each opposing bowl-shaped magnetic array. The construction of the fusion reactor is such that the plasma jets collide in the middle of the reactor between the two bowl-shaped magnetic arrays. An additional element, such as boron, is fed to the reactor when the goal is the fusion of elements such as hydrogen and boron.

### CROSS-REFERENCE TO RELATED APPLICATIONS

The present Utility patent application claims priority benefit of the U.S. provisional application for patent Ser. No. 63/310,521 filed on 15, Feb. 2022 under 35 U.S.C.119(e). The contents of this related provisional application are incorporated herein by reference for all purposes to the extent that such subject matter is not inconsistent herewith or limiting hereof.

### FIELD OF THE INVENTION

One or more embodiments of the invention generally relate to producing an aneutronic or a neutronic fusion reaction within a vacuum chamber by using opposing bowl-shaped magnetic fields, high-voltage electricity, and elements that can be fused to create energy or produce neutrons.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. In searching all prior art no other approach to controlled fusion utilizes the bowl-shaped magnetic fields that this invention uses. The bowl-shaped magnetic fields are essential in the construction of a controlled fusion device described herein and therefore make this invention unique. This invention also provides a far less costly and simpler method of fusing elements than any prior art. The bowl-shaped magnetic fields utilized in this invention cause the electrified plasma to be confined into narrow jets which are directed at each other and create a flat disc of plasma between the two magnetic arrays.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side view of a magnetic array utilized in an embodiment of the present invention.

FIG. 2 illustrates a top view of a magnetic array utilized in an embodiment of the present invention.

FIG. 3 illustrates an orthographic view of a magnetic array utilized in an embodiment of the present invention.

FIG. 4 illustrates a side view of a magnetic array embedded in a substrate as utilized in an embodiment of the present invention.

FIG. 5 illustrates an orthographic view of a magnetic array embedded in a substrate along with an anode and a cathode as utilized in an embodiment of the present invention.

FIG. 6 illustrates a top view of a magnetic array embedded in a substrate along with an anode and a cathode as utilized in an embodiment of the present invention.

FIG. 6A illustrates a sectional view of a magnetic array embedded in a substrate along with an anode and a cathode as utilized in an embodiment of the present invention.

FIG. 7 illustrates an orthographic view of two magnetic arrays embedded in a substrate along with anodes and cathodes as utilized in an embodiment of the present invention.

FIG. 8 illustrates a cross-sectional view of two magnetic arrays embedded in a substrate along with anodes and cathodes as utilized in an embodiment of the present invention.

FIG. 9 illustrates an orthographic view of a magnetic array embedded in a substrate along with multiple anodes and a cathode as utilized in an embodiment of the present invention.

FIG. 10 illustrates a top view of a magnetic array embedded in a substrate along with multiple anodes and a cathode as utilized in an embodiment of the present invention.

FIG. 10A illustrates a cross-sectional view of a magnetic array embedded in a substrate along with multiple anodes and a cathode as utilized in an embodiment of the present invention.

FIG. 11 illustrates a side view of a fusion reactor with opposing magnetic arrays as utilized in an embodiment of the present invention.

FIG. 11A illustrates an orthographic view of a fusion reactor with opposing magnetic arrays as utilized in an embodiment of the present invention.

FIG. 12 illustrates an end view view of a fusion reactor with opposing magnetic arrays as utilized in an embodiment of the present invention.

FIG. 12A illustrates a sectional view of a fusion reactor with opposing magnetic arrays as utilized in an embodiment of the present invention.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive. It is to be further understood that the present invention is not limited to the particular methodology, compounds, materials, manufacturing techniques, uses, and applications, described herein, as these may vary.

It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. More-over, the prescribed method steps of the foregoing embodiments may be implemented using any physical and/or hard-ware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

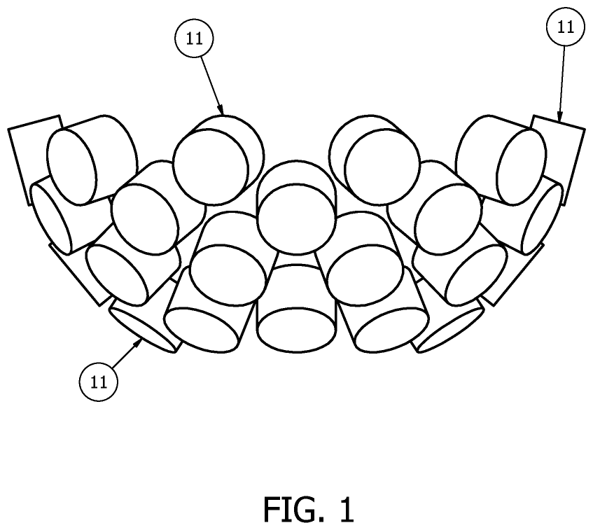

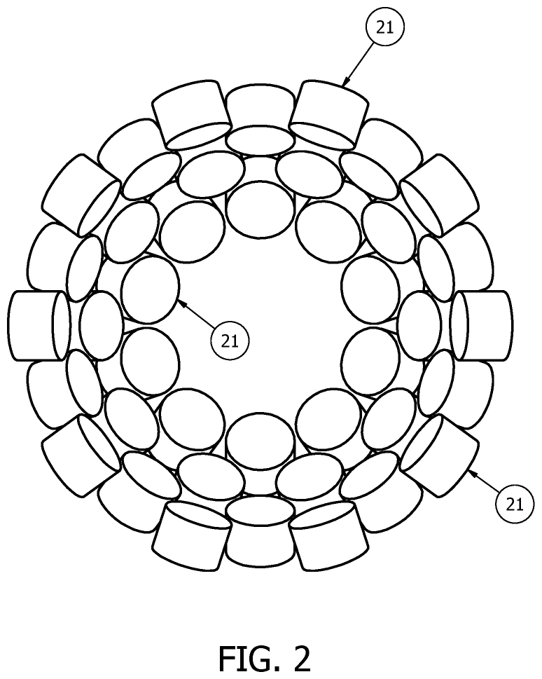

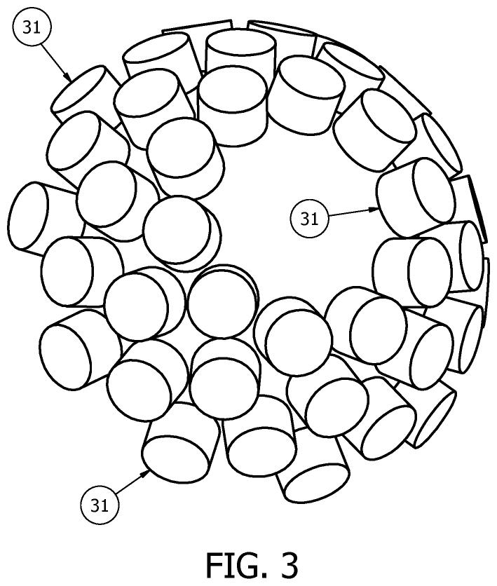

U.S. Pat. No. 8,638,186 B1 by the same inventor describes a bowl-shaped magnetic array and an example of such an array is shown in FIG. 1, FIG. 2, and FIG. 3. The magnetic arrays are constructed so that either all the north magnetic poles or all the south magnetic poles are oriented towards the center of the bowl-shaped array.

FIG. 1 is a side view of one of these bowl-shaped magnetic arrays showing the location of the magnets 11.

FIG. 2 is a top view of a bowl-shaped magnetic array showing the location of the magnets 21.

FIG. 3 is an orthographic view of the bottom of a bowl-shaped magnetic array showing the location of the magnets 31.

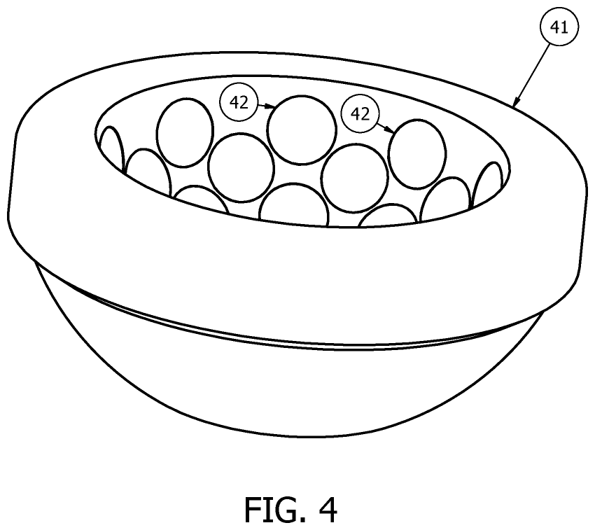

FIG. 4 shows a bowl-shaped magnetic array with the magnets 42 embedded in a bowl 41 constructed of a material which will not interfere with a magnetic field. Such materials are but not limited to polymers, composites, silicones, glass, ceramics, and wood.

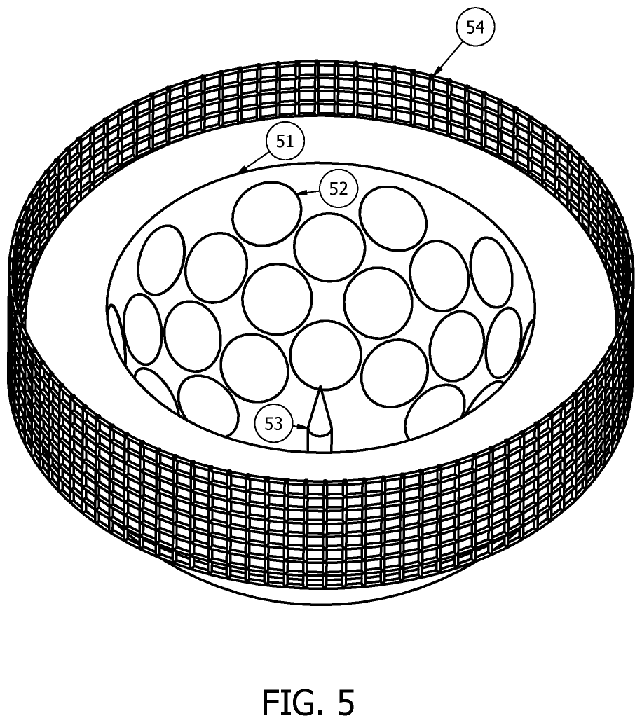

FIG. 5 shows an orthographic view of the bowl 51 constructed of any material that will not interfere with a magnetic field and the location of the magnets 52 within that bowl 51. Located at the bottom of the bowl 51 is an electrode 53 which is made of an electrically conductive material. Around the top rim of the bowl 51 is a screen 54 that is made of an electrically conductive material. The electrode 53 is supplied with high-voltage electricity and the screen 54 is supplied with high-voltage electricity of the opposite polarity of the electricity supplied to the electrode 53. Normally both the electrode 53 and the screen 54 are supplied with the high-voltage electricity from the same power supply with the electrode 53 connected to the positive side of the high-voltage power supply and the screen 54 connected to the negative side of the high voltage power supply. It may be desirable to supply the high-voltage electricity to the electrode 53 and the screen 54 in the reverse polarity so that the electrode 53 is connected to negative polarity high-voltage electricity and the screen 54 connected to positive polarity high-voltage electricity.

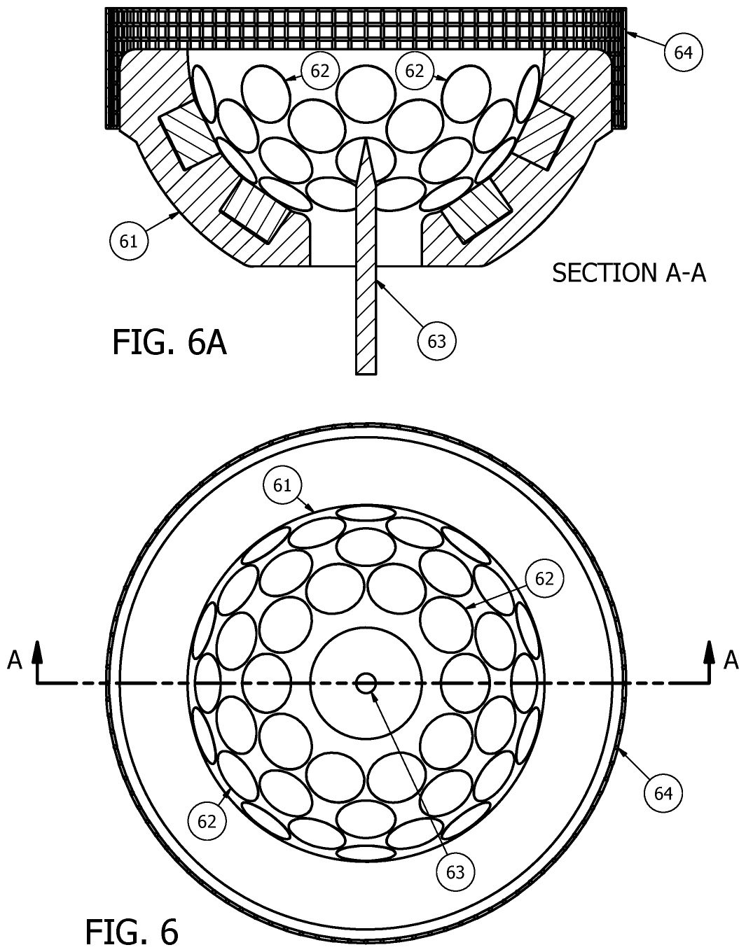

FIG. 6 shows a top view of the bowl 61, the location of the magnets 62, the location of the electrode 63, and the location of the electrically conductive screen 64.

FIG. 6A shows a sectional view of FIG. 6 below. FIG. 6A shows the bowl 61, and the location of the magnets 62, the location of the electrode 63, and the location of the electrically conductive screen 64. In FIG. 6 and FIG. 6A the location of the electrode 63 is shown centered on the axis of the bowl 61 and the array of magnets 62. It may be desirable to place the electrode 63 slightly off axis of the bowl 61 and the magnets 62 in the array. The distance from the tip of the electrode 63 to the top of the bowl 61 in FIG. 6A can be adjusted to maximize the fusion reactions in the present invention.

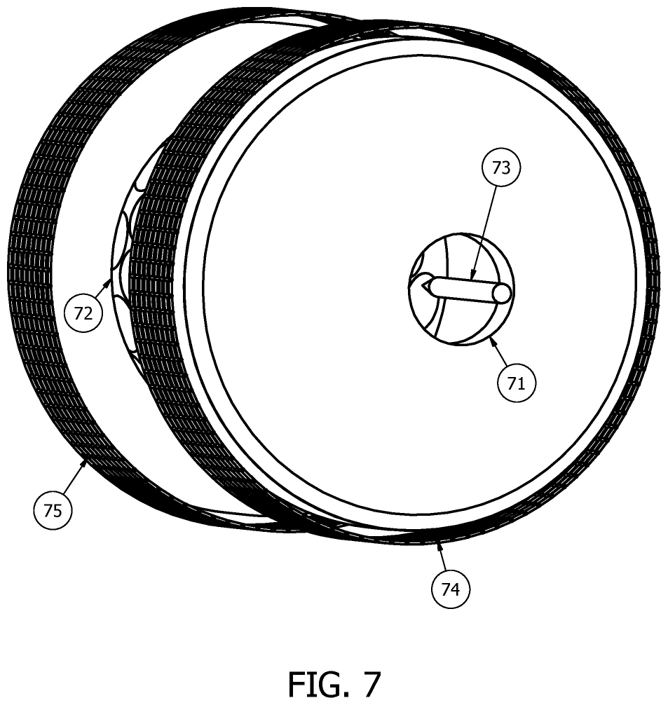

FIG. 7 shows two of the bowl-shaped arrays shown in FIGS. 6 and 6A arranged so the wide end of bowl 71 faces the wide end of the other bowl 72. The electrode 73 is shown centered on the axis of the bowl 71.

The two bowl shaped arrays shown in FIG. 7 are normally aligned so that that share a common center axis but it may be desirable to arrange them so that their axis are slightly misaligned to increase reactions.

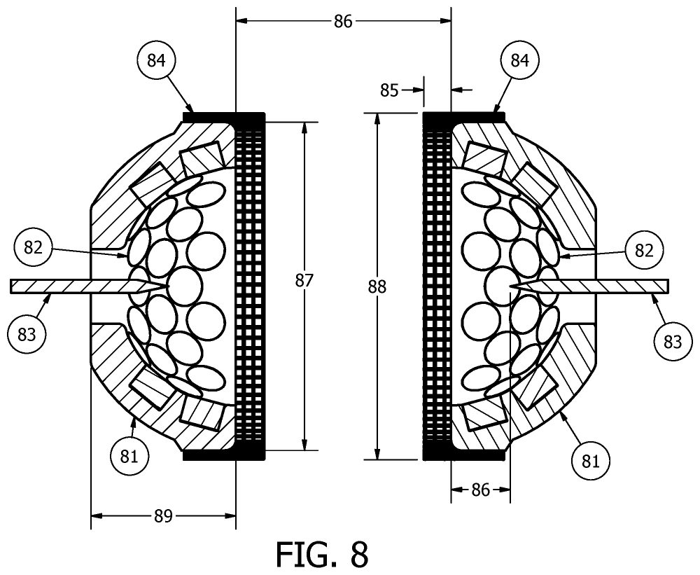

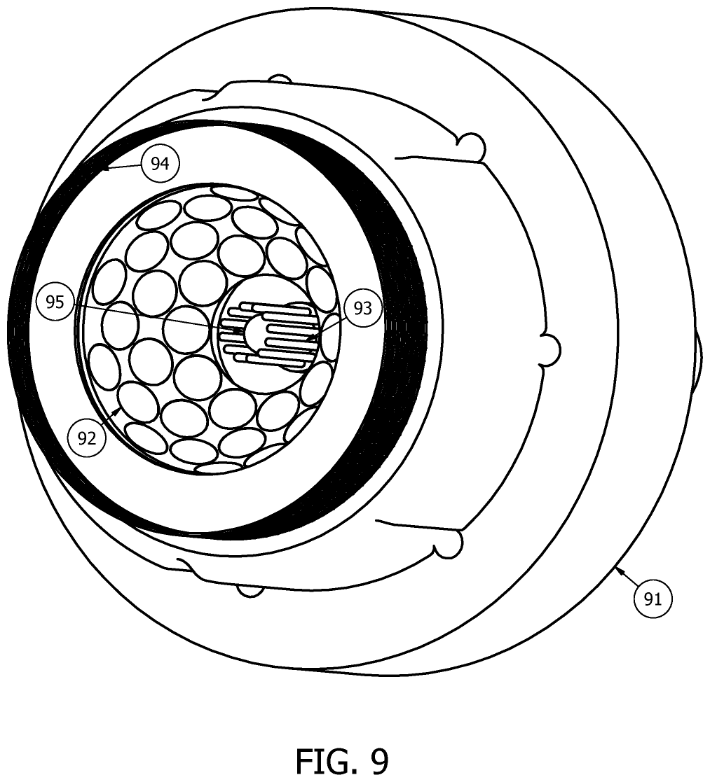

FIG. 8 shows a sectional view of FIG. 7 with the sectional view shown at the axis of the two bowls 81. The magnets 82 are located in the bowls 81 as shown in FIG. 8. The axis of the electrodes 83 is normally aligned with the axis of the bowls 81 and the array of magnets 82. It may be desirable to place the axis of the electrodes 83 slightly off from the axis of the bowls 81 and the array of magnets 82 to optimize the fusion reactions. The distance from the tip of the electrodes 83 to the top of the bowls 81 is indicated by dimension 86. Dimension 86 is adjusted to optimize fusion reactions. Dimension 85 indicates the distance from the top of the bowl 81 to the top of the screen 84. Dimension 84 is adjusted to optimize the fusion reactions and is relative to the diameter 87 of the bowl 81 and the depth of the bowl 81, which is indicated by dimension 89. Distance 87 is the outer diameter of the bowls 81 and dimension 88 is the outer diameter of the screen 84. The outer diameter 88 of the screens 84 is adjusted to optimize fusion reactions. When the reactor is in operation the entire assembly represented by FIG. 8 is placed in a high vacuum of at least 600 torr, but it can be used at different vacuum levels according to the desired results. The electrodes 83 are normally connected to positive polarity high-voltage electricity and both electrodes 83 can be supplied from the same high voltage source or from independent sources. The screens 84 can be supplied from the same high voltage source or from independent sources. The electrodes 83 can also be supplied with high voltage electricity of negative polarity and the screens with high voltage positive polarity according to desired results. In some cases it may be desirable to connect the electrode 83 on one side of the reactor to positive polarity high voltage electricity and the electrode 83 on the opposite side of the reactor to negative polarity high voltage electricity. In most cases the screen 84 will be of the opposite polarity as the electrode 83 on the same side of the reactor. The high voltage electricity supplied to the electrodes 83 and the screens 84 is normally supplied by the positive and negative poles of the same high voltage power supply. The pulsed high voltage electricity supplied to the electrodes 83 and the screens 84 is normally supplied at a frequency between 10 hz to 150 kilohertz direct current. The frequency of the high voltage electricity supplied to the electrodes 83 and the screens 84 is adjusted to optimize fusion reactions according to the other adjustment variables in the reactor. These variables include the polarity of the magnetic arrays, the size of the magnetic arrays, the gases and elements supplied to the reactor, the voltage supplied by the high voltage power supplies as well as other variables in the reactor. The distance between the bowls in the reactor is indicated by dimension 86 and this distance is adjusted to optimize fusion reactions. The size of the bowls 81, magnetic arrays 82, the electrodes 83, and the screens, and the spacing between the bowls are normally at the same ratios as shown in FIG. 8 but these dimensions can be varied to optimize fusion reactions. This reactor arrangement can be supplied with hydrogen and boron to produce aneutronic fusion or with deuterium and tritium to produce neutrons in fusion that produces heat and neutrons. Since neutrons are useful for other research objectives, operating the reactor with deuterium and tritium may be desired, but the main use for the current invention is to produce electrical charges through the aneutronic fusion of hydrogen and boron. The electrical charges produced in the fusion of boron and hydrogen can then be collected and converted to useable electrical power much more easily than when fusing deuterium and tritium. The high voltage electricity supplied to the electrodes 83 and the screens 84 can also be at one voltage for one side of the reactor and a different voltage for the opposite side of the reactor. Through experimentation one skilled in the art can determine the optimal sizes for the magnetic arrays 82 and the other components used in the current invention for the best results according to the desired objectives. When the arrangement shown in FIG. 8 is operated with both electrodes 83 supplied with the same polarity high voltage electricity in a vacuum of at least 600 torr, jets of high velocity plasma will be ejected towards the middle of the reactor from each bowl-shaped magnetic array which results in the two jets colliding and forming a disc of plasma between the two bowl-shaped magnetic arrays. When one electrode 83 is connected to positive polarity high-voltage electricity and the opposite electrode 83 is connected to negative polarity high-voltage electricity a narrow beam of plasma flows from one electrode 83 to the electrode on the opposite side of the reactor and no disc of plasma is formed between the bowls 81. The electrically conductive screens 84 can be made from any electrically conductive material. The screens 84 may also be constructed of solid material and the shape of the screens 84 can also modified in their shape. The screens may also be located anywhere outside of the bowls 81 that does not interfere with the plasma formed within the reactor. The shape of the bowls 81 can be modified substantially as long as the shaped of the magnetic array 82 is kept to a bowl shape. It is the shape of the magnetic array 82 that is important and not the shape of the bowl 81 shown in FIG. 8. The shape of the electrode 83 may also be modified and may be replaced by multiple electrodes as shown in FIG. 9.

FIG. 9 is an orthographic view of the bowl-shaped magnetic array 92 contained in a substrate base 91 in place of the bowl 81 shown in FIG. 8. The conductive screen 94 is located around the top rim of the bowl shaped magnetic array 92. Twelve electrodes 93 are located as shown in FIG. 9 with a rod of boron 95 in the middle of the circle of twelve electrodes. The twelve electrodes 93 are normally connected to the same polarity of a high voltage electrical power source, but each of the twelve electrodes 93 may also be connected to separate high voltage power sources to allow different voltages and/or electrical polarities at each individual electrode 93. The number of electrodes 93 and the shape of each electrode 93 in such an arrangement may be modified if desired. The substrate base 91 can be constructed of any material including but not limited to ceramic, glass, solid silicone, composites, and plastic that does not conduct electricity and does not interfere with a magnetic field.

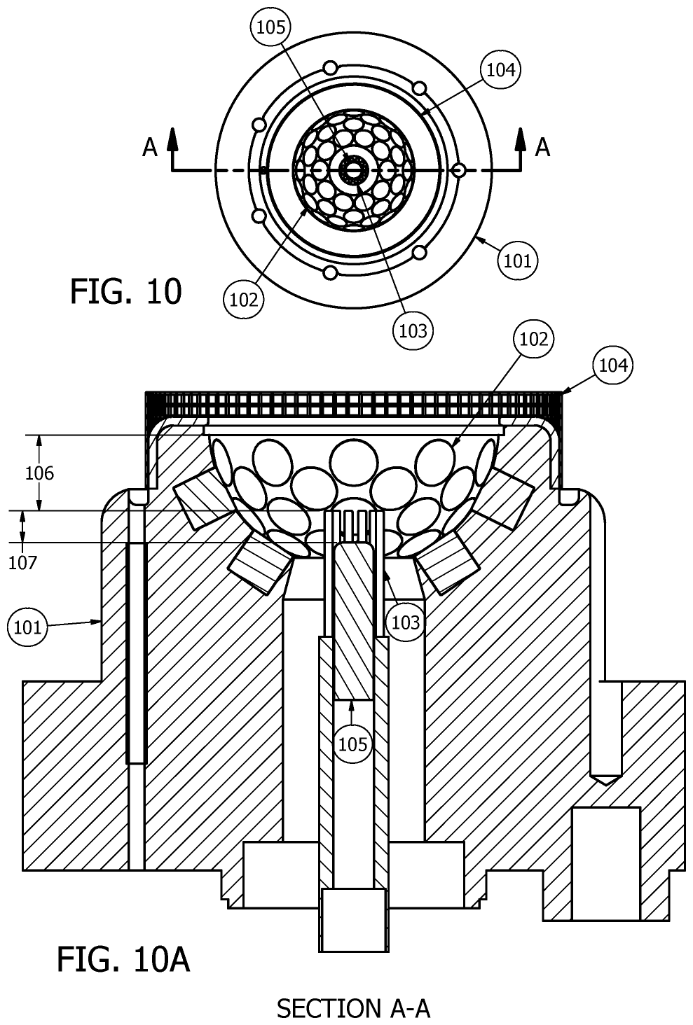

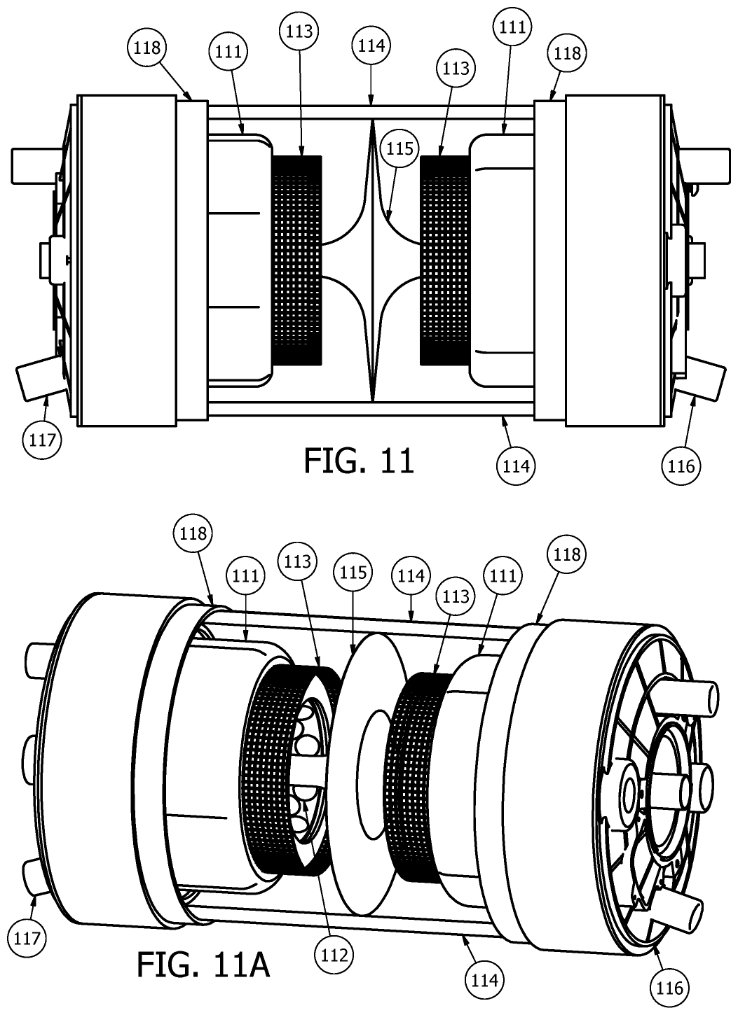

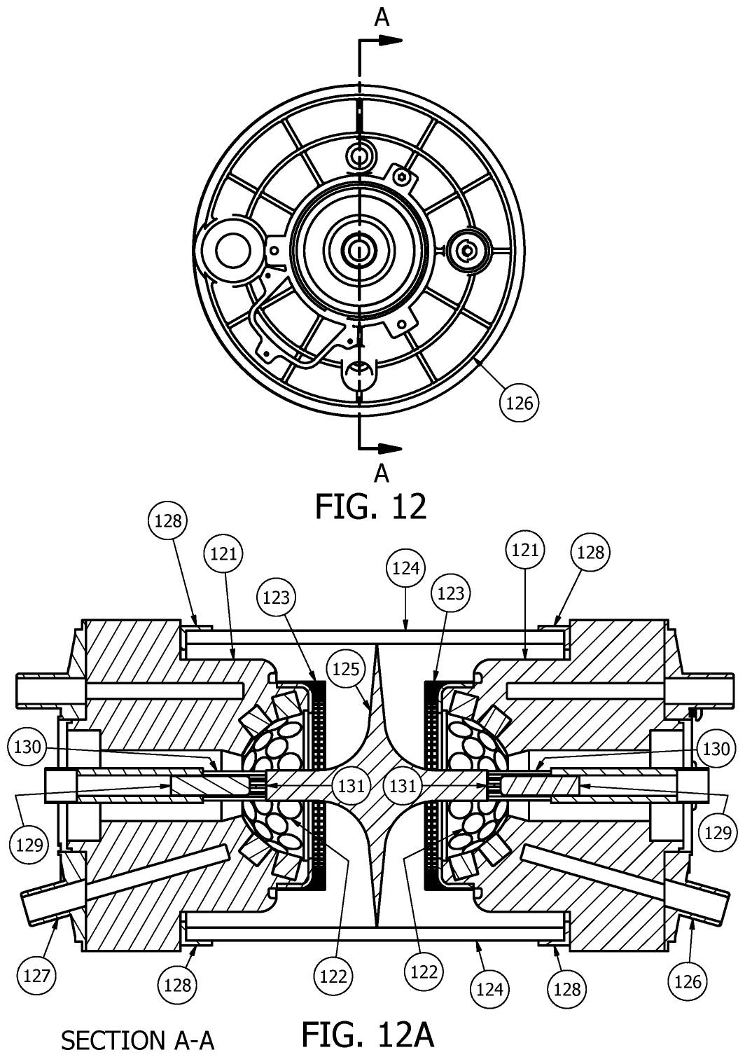

FIG. 10 is a top view of FIG. 9 and FIG. 10A is a scaled up sectional view of FIG. 10. The part numbers are the same in FIG. 10 and FIG. 10A. The substrate base 101 is bowl shaped on the interior where the magnetic array 102 is located, but the shape of the bottom of the substrate base 101 in FIG. 10A is not critical and may be modified to suit the application without interfering with the formation of plasma within the vacuum chamber. In FIG. 10A an array of electrodes 103 encircles the boron rod 105. Dimension 107 indicates the distance from the top of the boron rod 105 to the top of the array of electrodes 103. Dimension 106 indicates the distance from the top of the electrodes 103 to the top of the wide end of the bowl-shaped magnetic array 102. In operation dimensions 106 and 107 are adjusted to optimize fusion reactions. Although a single assembly as shown in FIG. 10 and FIG. 10A could be used in a vacuum environment to form a jet of plasma and initiate fusion, it is desirable to have another identical assembly so that the larger open ends of the two magnetic arrays 102 face each other as is shown in FIG. 11, FIG. 11A and FIG. 12A. Although it is desirable to use two identical assemblies as shown in FIG. 10 and FIG. 10A in such a configuration, it may also be of advantage to have one side of a reactor have a different configuration for some applications. Normally the magnetic polarity of the bowl-shaped magnetic arrays would be the same when two assemblies as used in the configuration shown in FIG. 11, FIG. 11A and FIG. 12A, it may be advantageous to use a north magnetic polarity configuration for one bowl-shaped magnetic array and a south magnetic polarity configuration for the other bowl-shaped magnetic array. To clarify, a north magnetic polarity bowl-shaped array has all of the magnets in that array oriented so that the north magnetic pole of each individual magnet faces inwards towards the center. A south magnetic polarity bowl-shaped array has all of the magnets in that array oriented so that the south magnetic pole of each individual magnet faces inwards towards the center.

FIG. 11 and FIG. 11A illustrate a side view and an orthographic of a control fusion reactor that utilizes the assembly illustrated in FIG. 10 and FIG. 10A on opposite ends of the reactor. FIG. 11A shows the substrate bases 111 and their location on opposite ends of the reactor. The bowl-shaped magnetic arrays 112 are located in the substrate bases 111 as shown in FIG. 11A and FIG. 12A. The electrically conductive screens 113 are located around the upper rim of the bowl-shaped magnetic arrays 112 as shown in FIG. 11 and FIG. 11A. A tube of borosilicate glass 114 connects both substrate bases 111 and silicone seals 118 on each end of the borosilicate glass tube 114 allow a high level vacuum to be established within the borosilicate glass tube 114. The borosilicate glass tube 114 can be replaced with other materials as long as they are not electrically conductive or interfere with the magnetic fields within the reactor. FIG. 11 and FIG. 11A illustrate the plasma 115 that forms between the magnetic arrays 112 when the reactor is constructed with both magnetic arrays 112 have the same magnetic polarity and both conductive screens 113 have a negative high-voltage electrical polarity.

FIG. 12 illustrates an end view of the reactor shown in FIG. 11 and FIG. 11A, and FIG. 12A is a sectional view of FIG. 12. In FIG. 12A the substrate bases 121 are aligned on the same center axis and are mounted on the ends of the borosilicate glass tube 124 which has silicone seals 128 on both ends that allow a high level vacuum to be established within the borosilicate glass tube 124. The electrically conductive screens 123 are located around the rims of the larger ends of the bowl-shaped magnetic arrays 122. The high-voltage electrodes 130 surround the rods of boron 129 in the center of the bowl-shaped magnetic arrays on each side of the reactor. The location of the high-voltage electrodes 130 and the boron rods 129 can be independently adjusted along the central axis of the reactor to maximize fusion reactions. The plasma 125 will form as shown in FIG. 12A when both bowl-shaped magnetic arrays 122 are constructed so that all the magnets in the arrays have the north magnetic poles facing inwards towards the central axis and the electrodes 130 are connected to positive polarity high voltage electricity and the conductive screens are connected to negative polarity high voltage electricity. Pass-throughs in both ends 126 and 127 of the reactor allow for high level vacuum to be established within the borosilicate glass tube 124 and a controlled amount of hydrogen gas to be fed to the interior of borosilicate glass tube 124. Pass-throughs in the ends of the reactor 126 and 127 also provide for high voltage electrical connections to the electrodes 130 and the electrically conductive screens 123. The present invention can be operated to fuse hydrogen and boron in an aneutronic reaction which will release electrical charges which are then collected and converted to useable electricity for home and industrial use. The present invention can also be used to fuse deuterium and tritium to produce neutrons for research purposes. Those who are skilled in the art will recognize that other elements than what are mentioned herein can be replaced with elements to produce heat energy and/or neutrons. There are many other configurations of fusion reactors but the present invention is the only known fusion reactor configuration to utilize bowl-shaped magnetic arrays. The present invention is able to fuse hydrogen and boron at much lower energies that what was previously believed due to the unique magnetic field within the bowl-shaped magnetic arrays 122. Inside the bowl-shaped magnetic array 122 a magnetic flip point 131 exists along the axis of the bowl-shaped magnetic array where the magnetic polarity suddenly flips direction. In addition at this magnetic flip point 131 the plasma is compressed inwards towards this magnetic flip point 131. When the electrodes 130 are adjusted to discharge within this magnetic flip point a dramatic increase in reactions is observed. When the boron rods 129 are positioned to the optimal location within the electrodes 130 and the electrodes 130 are located at the optimal position relative to the magnetic flip point 131 the fusion reaction is optimized. At this time research indicates that FIG. 12A illustrates the relative optimal location for the electrodes 130, and the boron rod 129 to optimize the fusion of hydrogen and boron within the present invention. The present invention can scaled to any size as long as the magnetic flux density at the magnetic flip point 131 is adequate. This magnetic flux density is dependent on the strength of the magnets in the magnetic array 122. When used to fuse hydrogen and boron in the present invention excess electrical charges are released. The excess electrical charges then flow to the conductive screens 123. The conductive screens are normally connected to the negative polarity side of a high voltage power supply through an electrical wire. On the return to the high voltage electrical supply this electrical wire passes through a step down transformer where the excess electrical charges created in the hydrogen boron fusion reaction are pulled out in the form of useable electrical power. Those skilled in the art will recognize that many other modifications can be made to the present invention including replacing the magnets in the bowl-shaped arrays with electromagnets. Electromagnets in such a configuration could be sequenced electronically to provide movement of the magnetic field within the bowl-shaped arrays including simulating the rotation of the magnetic arrays. More information including animations of this process and videos of experimental reactors in operation can be found at www.primerfusion.org.

What is claimed:

1. A controlled fusion reactor comprising: two bowl-shaped magnetic arrays of the same magnetic orientation aligned on the same axis with the wide end of each magnetic array facing each other and each magnetic array comprising a plurality of magnets, said plurality of magnets comprising a plurality of north poles, said plurality of magnets further comprising a plurality of south poles, said plurality of magnets being disposed to form arrays with all the same magnetic poles facing inwards, said arrays comprising a wide end, said array further comprising a narrow end, said narrow end comprising an aperture, said plurality of magnets being operable to induce an ionic flow, said ionic flow being disposed to flow from said aperture towards said wide end, said ionic flow being operable to manipulate at least one object positioned in proximity to said array, wherein said array comprises a diameter, said array further comprising a depth, said array further comprising a base and said array further comprising a radius for a parabolic curvature of said magnetic array, and with each magnetic array having an electrode positioned near said aperture and a conductive screen surrounding the outer rim of the wide end of each said magnetic array with the said conductive screen being of opposite electrical polarity of said electrode.

2. The controlled fusion reactor of claim 1 wherein the magnetic orientation of one bowl-shaped magnetic field is of north magnetic polarity wherein all the north magnetic poles face inwards towards the center of the bowl-shaped array and the opposite bowl-shaped magnetic array is of south magnetic orientation wherein all the south magnetic poles face inwards towards the center of the bowl-shaped array.

3. The controlled fusion reactor of claim 1 wherein the electrodes within both bowl-shaped magnetic arrays have the same electrical polarity.

4. The controlled fusion reactor of claim 1 wherein the electrodes within both bowl-shaped magnetic arrays have opposite electrical polarities.

5. The controlled fusion reactor of claim 1 wherein a high vacuum level is maintained around the magnetic arrays.

6. The controlled fusion reactor of claim 1 wherein hydrogen gas is supplied to the area between the magnetic arrays.

7. The controlled fusion reactor of claim 1 wherein boron is supplied to the area between the magnetic arrays.

8. The controlled fusion reactor of claim 1 wherein high-voltage high frequency direct current electricity is supplied to the electrodes.

9. The controlled fusion reactor of claim 1 wherein high-voltage high frequency direct current electricity is supplied at one frequency to one electrode and at a different frequency to the opposite electrode.

10. The controlled fusion reactor of claim 1 where high voltage electricity is supplied to the electrodes and the conductive screens in a sequence of different frequencies with each electrode fed by independent high voltage sources so that the frequency of the high voltage electricity supplied to each electrode is the same or different.

11. The controlled fusion reactor of claim 1 wherein elements which produce neutrons when they undergo nuclear fusion are supplied to the area between the magnetic arrays.

12. The controlled fusion reactor of claim 1 wherein the magnetic arrays are held by a substrate base.

13. The controlled fusion reactor of claim 1 wherein the magnetic arrays comprise a plurality of neodymium magnets.

14. The controlled fusion reactor of claim 1 wherein the magnetic arrays comprise plurality of electromagnets.

15. The controlled fusion reactor of claim 1 wherein the magnetic arrays comprise plurality of electromagnets which can be sequenced electronically to simulate rotation of the magnetic arrays.

16. The controlled fusion reactor of claim 1 wherein one magnetic array is larger than the other magnetic array.

17. The controlled fusion reactor of claim 1 wherein a singular magnetic array is used.

18. The controlled fusion reactor of claim 1 wherein multiple bowl-shaped arrays are oriented so that they form a spherical arrangement with the wide ends of all the arrays facing inwards.

19. The controlled fusion reactor of claim 1 wherein multiple electrodes are used in each magnetic array in place of a singular electrode.

20. The controlled fusion reactor of claim 1 wherein the electrically conductive screen is replaced with a solid electrically conductive material made in the same shape or other shapes and located around the outside of magnetic arrays.
